(19) United States
(12) Patent Application Publication
(10) Pub. No.: US 2020/0395631 A1
(43) Pub. Date: Dec. 17, 2020

(54) SOLID ELECTROLYTE COMPOSITE HAVING SUPERIOR FLEXIBILITY AND STRENGTH AND METHOD OF MANUFACTURING THE SAME

(71) Applicants: Hyundai Motor Company, Seoul (KR); Kia Motors Corporation, Seoul (KR); Ulsan National Institute of Science and Technology, Ulsan (KR)

(72) Inventors: Sang Mo Kim, Hwaseong (KR); Hong Seok Min, Yongin (KR); Sang Heon Lee, Yongin (KR); Jae Min Lim, Suwon (KR); Ju Yeong Seong, Suwon (KR); Yun Sung Kim, Seoul (KR); Sang Young Lee, Ulsan (KR); Jung Hwan Kim, Ulsan (KR); Sang Ho Hong, Ulsan (KR)

(21) Appl. No.: 16/741,174

(22) Filed: Jan. 13, 2020

(30) Foreign Application Priority Data
Jun. 11, 2019 (KR) 10-2019-0068959

(51) Int. Cl. H01M 10/0565

(52) U.S. Cl. CPC H01M 10/0565; H01M 2300/0082

(57) ABSTRACT

Disclosed are a solid electrolyte composite having high flexibility and strength, a method of manufacturing the same and an electrochemical device including the same. The solid electrolyte composite includes a matrix including a solid electrolyte, and fibrous polymers located in the same layer as the matrix and distributed in the matrix, and is manufactured by preparing a first solution including a polymer material, preparing a second solution including a solid electrolyte, producing fibrous polymers by electrospinning the first solution and simultaneously obtaining a structure configured such that the solid electrolyte is loaded between the fibrous polymers by electrospraying the second solution, and pressing the structure.

### CROSS REFERENCE TO RELATED APPLICATION

The present application claims priority based on Korean Patent Application No. 10-2019-0068959, filed on Jun. 11, 2019, the entire content of which is incorporated herein for all purposes by this reference.

### TECHNICAL FIELD

The present invention relates to a solid electrolyte composite having superior flexibility and strength, a method of manufacturing the same, and an electrochemical device including the same.

### BACKGROUND

A rechargeable secondary battery has been used not only in small-sized electronic devices such as mobile phones and laptop computers, but also in large-sized transport vehicles such as hybrid vehicles and electric vehicles. Accordingly, there is a need to develop a secondary battery having greater stability and energy density.

Conventional secondary batteries are mostly configured such that cells are formed using an organic solvent (liquid electrolyte), and thus limitations are imposed on the extent to which stability and energy density may be improved. In the related art, an all-solid-state battery using a solid electrolyte has provided advantages in that a cell may be manufactured in a safe and simple manner because an organic solvent is excluded.

However, the all-solid-state battery is problematic in that the actual energy density and power output thereof do not reach those of conventional lithium ion batteries using a liquid electrolyte. The all-solid-state battery may be bulky and heavy compared to conventional lithium ion batteries because an electrolyte membrane containing a solid electrolyte is located between a cathode and an anode, resulting in lowered energy density per unit volume and decreased energy density per unit weight. In the case in which the electrolyte membrane is thinned to prevent the above problems, a short circuit between the cathode and the anode may occur.

Therefore, it is necessary to develop an electrolyte membrane which is excellent in mechanical strength and may thus be maintained in a stable state between the electrodes and does not damage the energy density of the battery.

### SUMMARY OF THE INVENTION

In one preferred aspect, provided is a solid electrolyte composite having high strength, which is capable of forming a thin but stable membrane between electrodes.

In further preferred aspect, provided is a solid electrolyte composite having high strength and flexibility.

Also, in one preferred aspect, provided is a solid electrolyte composite having high ionic conductivity.

The objectives of the present invention are not limited to the foregoing, and will be able to be clearly understood through the following description and to be realized by the means described in the claims and combinations thereof.

In an aspect, provided is a solid electrolyte composite, which may include: a matrix including a solid electrolyte and fibrous polymers located in the same layer as the matrix and distributed in the matrix.

The solid electrolyte may suitably include a sulfide-based solid electrolyte, an oxide-based solid electrolyte, or combinations thereof.

The fibrous polymers may suitably include one or more selected from the group consisting of polyethylene terephthalate, polyimide, polyamide, polysulfone, polyvinylidene fluoride, polyacrylonitrile, polyethylene, and polypropylene.

The fibrous polymers may suitably have an average diameter of about 0.001 μm to 10 μm and an average length of about 150 μm to 10,000 μm.

The solid electrolyte composite may suitably have a thickness of about 1 μm to 100 μm.

The solid electrolyte composite may be a free-standing thin film.

The solid electrolyte composite may suitably have a density variation of about 15% or less.

The solid electrolyte composite may suitably have a density of about 1.3 g/cm³ to 4.6 g/cm³.

In an aspect, provided is a method of manufacturing a solid electrolyte composite. The method may include: preparing a first solution including a polymer material, preparing a second solution including a solid electrolyte, producing fibrous polymers by electrospinning the first solution and simultaneously obtaining a structure configured such that the solid electrolyte is loaded between the fibrous polymers by electro spraying the second solution, and pressing the structure.

The method of manufacturing the solid electrolyte composite may further include drying the pressed structure.

The polymer material may suitably include one or more selected from the group consisting of polyethylene terephthalate, polyimide, polyamide, polysulfone, polyvinylidene fluoride, polyacrylonitrile, polyethylene, and polypropylene.

The first solution may include an amount of about 5 wt % to 30 wt % of the polymer material based on the total weight of the first solution.

The solid electrolyte may suitably include a sulfide-based solid electrolyte, an oxide-based solid electrolyte, or combinations thereof.

The solid electrolyte may suitably have an average particle diameter of about 0.001 μm to 10 μm.

The second solution may suitably include an amount of about 5 wt % to 50 wt % of the solid electrolyte based on the total weight of the second solution.

The electrospinning may be performed using a first unit including a first tank for storing the first solution and a pin-shaped first nozzle for jetting the first solution stored in the first tank.

The electrospinning may be performed under conditions of an applied voltage of about 1 kV to 30 kV, a jetting distance of about 5 cm to 20 cm and a jetting speed of about 5 μl/min to 20 μl/min.

The electrospraying may be performed using a second unit including a second tank for storing the second solution and a pin-shaped second nozzle for jetting the second solution stored in the second tank.

The electrospraying may be performed under conditions of an applied voltage of about 1 kV to 30 kV, a jetting distance of about 5 cm to 20 cm and a jetting speed of about 50 μl/min to 1,000 μl/min.

According to the preferred aspects of the present invention, a solid electrolyte composite may form a thin but stable membrane between electrodes, and thus an all-solid-state battery having high energy density and superior stability may be obtained using the same.

According to the preferred aspects of the present invention, the solid electrolyte composite may efficiently form a lithium ion transfer path therein, and thus an all-solid-state battery having good charging/discharging efficiency may be obtained using the same.

The effects of the present invention are not limited to the foregoing, and should be understood to include all effects that can be reasonably anticipated from the following description. Other aspects of the invention are disclosed infra.

### BRIEF DESCRIPTION OF DRAWINGS

FIG. 1 is a cross-sectional view schematically showing an exemplary all-solid-state battery according to an exemplary embodiment of the present invention;

FIG. 2 is a cross-sectional view schematically showing an exemplary solid electrolyte composite according to an exemplary embodiment of the present invention;

FIG. 3 is a flowchart showing an exemplary process of manufacturing an exemplary solid electrolyte composite according to an exemplary embodiment of the present invention;

FIG. 4 schematically shows an exemplary first unit and an exemplary second unit used in an exemplary process of manufacturing an exemplary solid electrolyte composite according to an exemplary embodiment of the present invention;

FIG. 5 shows the result of observation with a scanning electron microscope (SEM) of the surface of an exemplary structure before pressing in Example according to an exemplary embodiment of the present invention;

FIG. 6 shows the result of observation with a SEM of the cross-section of a support after impregnation with a second solution and before pressing in Comparative Example in the present disclosure;

FIG. 7A shows the result of observation with a SEM of the surface of an exemplary solid electrolyte composite in Example according to an exemplary embodiment of the present invention, and FIG. 7B shows the result of observation with a SEM of the cross-section thereof;

FIG. 8 shows the result of observation with a SEM of the cross-section of a solid electrolyte composite in Comparative Example of the present disclosure; and

FIG. 9 shows the result of observation with an optical microscope of the surface of an exemplary solid electrolyte composite in Example according to an exemplary embodiment of the present invention.

### DETAILED DESCRIPTION

The above and other objectives, features and advantages of the present invention will be more clearly understood from the following preferred embodiments taken in conjunction with the accompanying drawings. However, the present invention is not limited to the embodiments disclosed herein, and may be modified into different forms. These embodiments are provided to thoroughly explain the invention and to sufficiently transfer the spirit of the present invention to those skilled in the art.

Throughout the drawings, the same reference numerals will refer to the same or like elements. For the sake of clarity of the present invention, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present invention. Similarly, the “second” element could also be termed a “first” element. As used herein, the singular forms are intended to include the plural forms as well, unless the context clearly indicates otherwise.

It will be further understood that the terms “comprise”, “include”, “have”, sand the like, when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting the measurements that essentially occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

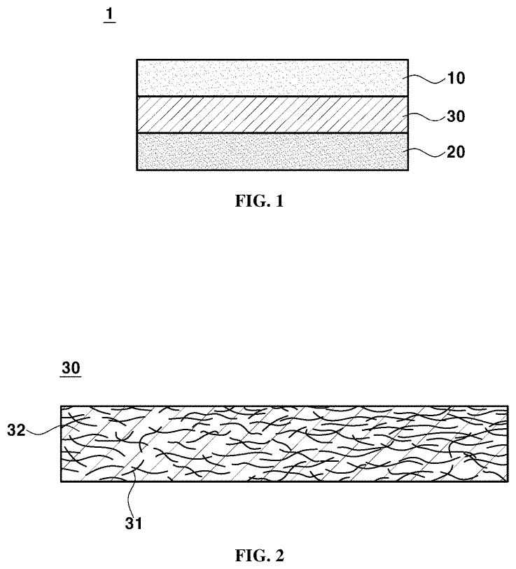

FIG. 1 is a cross-sectional view schematically showing an exemplary all-solid-state battery 1 according to an exemplary embodiment of the present invention. With reference thereto, the all-solid-state battery 1 includes a cathode 10, an anode 20 and a solid electrolyte composite 30 disposed between the cathode 10 and the anode 20.

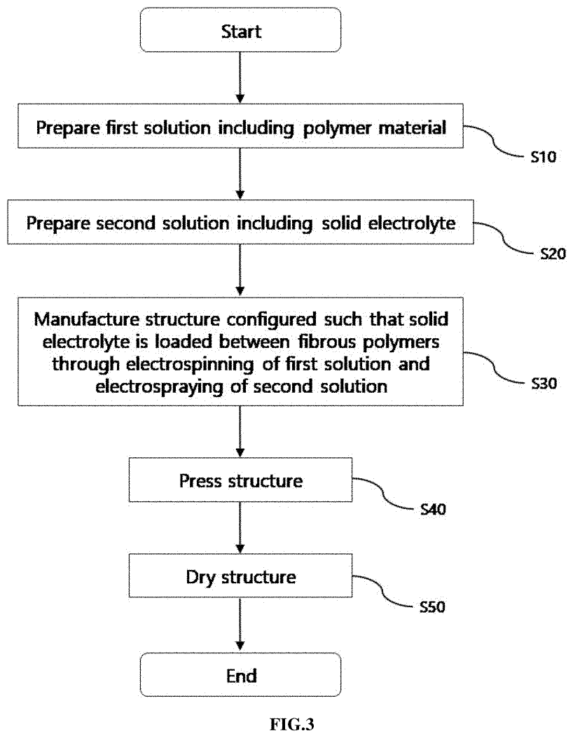

FIG. 2 is a cross-sectional view schematically showing an exemplary solid electrolyte composite 30 according to an exemplary embodiment of the present invention. With reference thereto, the solid electrolyte composite 30 may include a matrix 31 including a solid electrolyte and fibrous polymers 32 located in the same layer as the matrix 31 and distributed in the matrix 31.

The matrix 31 may result from pressing a solid electrolyte. For example, the matrix 31 may be formed by pressing the particles of the solid electrolyte in the thickness direction of the solid electrolyte composite 30. The boundaries of the particles of the solid electrolyte may be obscured by pressure and thus a kind of thin film is formed.

The solid electrolyte may suitably include a sulfide-based solid electrolyte, an oxide-based solid electrolyte, or combinations thereof. The sulfide-based solid electrolyte and the oxide-based solid electrolyte are not particularly limited, and may include typical examples thereof.

The fibrous polymers 32 may act as a kind of support for the matrix 31. Since the fibrous polymers 32 are uniformly distributed in the matrix 31, they may be maintained in a stable state between the cathode 10 and the anode 20 even when the solid electrolyte composite 30 is formed thin.

The fibrous polymers 32 may suitably include one or more selected from the group consisting of polyethylene terephthalate, polyimide, polyamide, polysulfone, polyvinylidene fluoride, polyacrylonitrile, polyethylene, and polypropylene. The kind of the fibrous polymers 32 may be appropriately selected depending on the operating temperature of the all-solid-state battery 1 in order to prevent degradation due to heat generated from the all-solid-state battery 1.

The fibrous polymers 32 may suitably have an average diameter of about 0.001 μm to 10 μm and an average length of about 150 μm to 10,000 μm. The average diameter and the average length may be measured through observation with an optical microscope. The number of samples is preferably large, for example, about 10 greater more, and more preferably, the diameter and length of about 100 or greater fibrous polymers 32 are measured and averaged. When the average diameter and the average length are less than the above lower limits, the effect of increasing the rigidity of the solid electrolyte composite 30 by the fibrous polymers 32 may become insignificant. On the other hand, when the average diameter and the average length exceed the above upper limits, the particles of the solid electrolyte may not be efficiently loaded between the fibrous polymers 32, making it difficult to form the matrix 31 so as to be dense.

The solid electrolyte composite 30 may suitably include an amount of about 50 wt % to 90 wt % of the matrix 31 and an amount of about 10 wt % to 50 wt % of the fibrous polymers 32, based on the total weight of the solid electrolyte composite 30. When the amounts of the matrix 31 and the fibrous polymers 32 fall in the above ranges, the rigidity and ionic conductivity of the solid electrolyte composite 30 may be uniformly exhibited.

The thickness of the solid electrolyte composite 30 may suitably fall in the range of about 1 μm to 100 μm. When the thickness thereof is less than the above lower limit, short-circuiting between the cathode 10 and the anode 20 may not be prevented. On the other hand, when the thickness thereof exceeds the above upper limit, energy density per unit volume and energy density per unit weight may decrease.

As shown in FIG. 2, the solid electrolyte composite 30 is configured such that the fibrous polymers 32 are uniformly distributed in the densely formed matrix 31, and may thus be provided in the form of a free-standing thin film. As used herein, the term “free-standing” means that the shape may be maintained by itself without an additional support structure (for example, a substrate made of film or glass).

The variation in the density of the solid electrolyte composite 30 may suitably be about 15% or less. Particularly, the solid electrolyte composite 30 may be configured such that the difference between the density of any one region of the solid electrolyte composite 30 and the density of any other region thereof may be about 15% or less. The lower limit of the variation in the density of the solid electrolyte composite 30 is not particularly limited, and may be 0% or greater than 0%. The fibrous polymers 32 may be uniformly distributed in the matrix 31, and thus the variation in the density of the solid electrolyte composite 30 may be very low.

Here, the solid electrolyte composite 30 may have suitably a density of about 1.3 g/cm³ to 4.6 g/cm³. Accordingly, the solid electrolyte composite 30 may have a density falling in the above numeric range and a density variation of about 15% or less.

FIG. 3 is a flowchart showing an exemplary process of manufacturing an exemplary solid electrolyte composite 30 according to an exemplary embodiment of the present invention. With reference thereto, the method of manufacturing the solid electrolyte composite 30 may include preparing a first solution including a polymer material (S10), preparing a second solution including a solid electrolyte (S20), producing fibrous polymers 32 by electrospinning the first solution and simultaneously obtaining a structure configured such that the solid electrolyte is loaded between the fibrous polymers 32 by electrospraying the second solution (S30), pressing the structure (S40) and drying the pressed structure (S50).

Preparing the first solution (S10) and preparing the second solution (S20) may include steps in which materials for the solid electrolyte composite 30 may be prepared, and the sequence thereof is not particularly limited. For the sake of description, preparing the first solution (S10) may be performed first in an exemplary embodiment of the present invention, but the present invention is not limited thereto.

Preparing the first solution (S10) may include a step of preparing an electrospinning solution by adding the polymer material to a solvent.

The polymer material may be a material for the fibrous polymers 32, and may suitably include one or more selected from the group consisting of polyethylene terephthalate, polyimide, polyamide, polysulfone, polyvinylidene fluoride, polyacrylonitrile, polyethylene, and polypropylene, but is not limited thereto, and may include monomers of the aforementioned polymers. For example, in order to obtain fibrous polymers 32 including polyimide, polyimide may be used as the polymer material, and the monomer thereof, that is, a mixture of dianiline and dianhydride, may be used.

The solvent is not particularly limited, and may be appropriately selected depending on the kind of the polymer material.

The first solution may suitably include an amount of about 5 wt % to 30 wt % of the polymer material based on the total weight of the first solution. When the amount of the polymer material falls in the above range, electrospinning processability may be improved.

Preparing the second solution (S20) may include a step of preparing an electrospraying solution by adding the solid electrolyte to a solvent.

The solid electrolyte may suitably include a sulfide-based solid electrolyte, an oxide-based solid electrolyte, or combinations thereof. The sulfide-based solid electrolyte and the oxide-based solid electrolyte are not particularly limited, and may include any materials suitably for a solid electrolyte or examples thereof (e.g. conventional substances).

The solid electrolyte included in the second solution may be in the form of particles before pressing in order to form the matrix 31, and the average particle diameter thereof may be about 0.001 μm to 10 μm. The average particle diameter may be measured using a commercially available laser-diffraction-scattering particle size analyzer, for example, a Microtrac particle size distribution meter. Furthermore, the average particle diameter may be determined by arbitrarily extracting 200 particles on an electron microscope image and measuring the sizes thereof. When the average particle diameter of the solid electrolyte falls in the above range, the solid electrolyte may be uniformly distributed in the second solution.

The second solution may include an amount of about 5 wt % to 50 wt % of the solid electrolyte based on the total weight of the second solution. When the amount of the solid electrolyte is less than the above lower limit, the amount of the solid electrolyte that is jetted per electrospraying time may be substantially reduced, thus deteriorating processability. On the other hand, when the amount thereof exceeds the above upper limit, the particles of the solid electrolyte may become aggregated.

Manufacturing the structure (S30) may include a step of loading the solid electrolyte between the fibrous polymers 32 formed through electro spinning by simultaneously performing electro spinning of the first solution and electrospraying of the second solution.

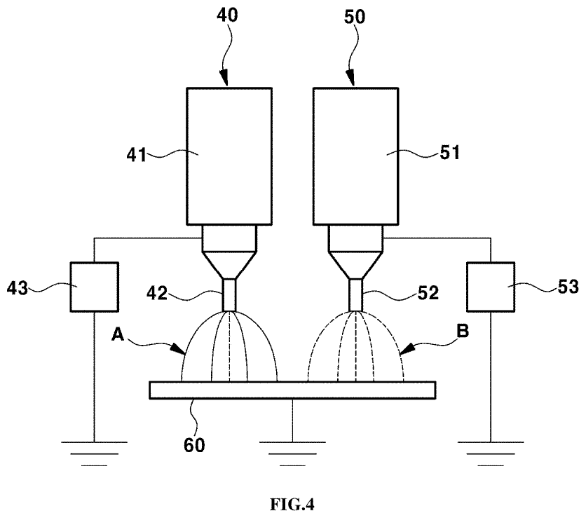

FIG. 4 schematically shows an exemplary first unit 40, in which electro spinning of the first solution A is performed, and an exemplary second unit 50, in which electrospraying of the second solution B is performed.

The first unit 40 may include a first tank 41 for storing the first solution A, a pin-shaped first nozzle 42 connected to the first tank 41 to jet the first solution A, and a first power supply 43 for applying a voltage between the first nozzle 42 and a collector 60.

With reference to FIG. 4, the first unit 40 is depicted as including a single nozzle 42, but is not limited thereto, and may include a nozzle block (not shown) comprising a plurality of nozzles. Here, the number of nozzles is not limited, but, for example, an 18-pin (inner diameter of about 0.86 mm) or 23-pin (inner diameter of about 0.33 mm) nozzle block, may be used.

The first solution may be electrospun under conditions of a jetting distance of about 5 cm to 20 cm and a jetting speed of about 5 μl/min to 20 μl/min at a voltage of about 1 kV to 30 kV applied between the first nozzle 42 and the collector 60 using the first power supply 43. Here, the jetting distance may be the distance between the first nozzle 42 and the collector 60, and the jetting speed may be the speed at which the first solution A is jetted through the first nozzle 42.

The second unit 50 may include a second tank 51 for storing the second solution B, a pin-shaped second nozzle 52 connected to the second tank 51 to jet the second solution B, and a second power supply 53 for applying a voltage between the second nozzle 52 and the collector 60.

With reference to FIG. 4, the second unit 50 is depicted as including a single nozzle 52, but may include a nozzle block (not shown) comprising a plurality of nozzles. Here, the number of nozzles is not limited, but, for example, an 18-pin (inner diameter of about 0.86 mm) or 23-pin (inner diameter of about 0.33 mm) nozzle block, may be used.

The first power supply 43 and the second power supply 53 are separately depicted as being spaced apart from each other, but the present invention is not limited thereto, and voltage may be applied to each of the first unit 40 and the second unit 50 using a single power supply.

The second solution may be electrosprayed under conditions of a jetting distance of about 5 cm to 20 cm and a jetting speed of about 50 μl/min to 1,000 μl/min at a voltage of about 1 kV to 30 kV applied between the second nozzle 52 and the collector 60 using the second power supply 53. Here, the jetting distance may be the distance between the second nozzle 52 and the collector 60, and the jetting speed may be the speed at which the second solution B is jetted through the second nozzle 52.

FIG. 5 shows the result of observation with a SEM of the structure manufactured through electro spinning of the first solution and electrospraying of the second solution. Particularly, the surface of the structure may be observed. With reference thereto, the structure may include the fibrous polymers formed through electrospinning of the first solution and the solid electrolyte formed through electro spraying of the second solution. For example, the solid electrolyte may be uniformly distributed in the voids between the fibrous polymers, which will be described in detail in connection with the Example later.

Pressing the structure (S40) may include a step of forming a dense matrix 31 including the solid electrolyte by pressing the structure in a thickness direction thereof. When the matrix 31 is densely formed, the lithium ion transfer path may be formed in the solid electrolyte composite 30.

The process of pressing the structure is not particularly limited, but may include, for example, pressing using a roll press.

Drying the structure (S50) may include a step of removing the remaining solvent from the structure. The drying conditions are not particularly limited, and may include a temperature and time for preventing degradation of the solid electrolyte and the fibrous polymers.

The structure thus pressed and dried may be cut to an appropriate area, and may be used as the solid electrolyte composite 30.

A better understanding of the present invention will be given through the following examples, which are merely set forth to illustrate the present invention but are not to be construed as limiting the scope of the present invention.

### Example

### Preparation of Example

(S10) A first solution was prepared by adding a polymer material composed of 4,4′-oxydianiline and pyromellitic dianhydride (PMDA) to a dimethylformamide solvent. Here, the amount of the polymer material was about 15 wt % (based on the weight of the first solution).

(S20) A second solution was prepared by adding a sulfide-based solid electrolyte and a polybutadiene binder to an o-xylene solvent. Here, the amount of the sulfide-based solid electrolyte was about 40 wt % (based on the weight of the second solution).

(S30) A structure was manufactured by introducing the first solution and the second solution into an electrospinning and electrospraying device as shown in FIG. 4. Specifically, the applied voltage was about 11 kV and 18 kV, and the jetting distance was about 10 cm and 7.5 cm. The speed of jetting of the first solution was about 5 μl/min, and the speed of jetting of the second solution was about 170 μl/min, and electrospinning and electrospraying were performed for about 200 min.

(S40) The structure was pressed to a thickness of about 70 μm using a roll press.

(S50) The pressed structure was dried, thereby obtaining a solid electrolyte composite.

### Preparation of Comparative Example

A kind of porous support comprising fibrous polymers by electrospinning the first solution of Example was manufactured. The support was incorporated in the second solution of Example so that the solid electrolyte was loaded in the support. The resulting product was pressed using a roll press and then dried, thereby obtaining a solid electrolyte composite.

### Test Example 1—SEM Observation

The surface and cross-section of the solid electrolyte composite of each of Example and Comparative Example were observed with a SEM. The results are shown in FIGS. 5 to 8.

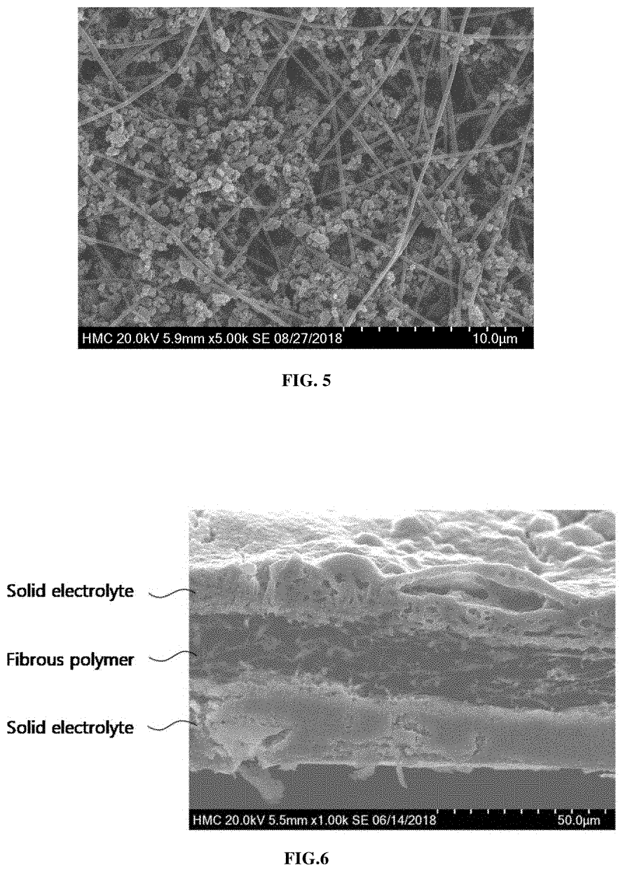

FIG. 5 shows the result of observation with a SEM of the surface of the structure before pressing in Example of the present invention. FIG. 6 shows the result of observation with a SEM of the cross-section of the support after impregnation with the second solution and before pressing in Comparative Example.

With reference to FIG. 5, in the structure of Example, it can be seen that the particles of the solid electrolyte were uniformly distributed between the fibrous polymers. In contrast, with reference to FIG. 6, in the support of Comparative Example, it can be seen that the solid electrolyte did not penetrate into the fibrous polymers.

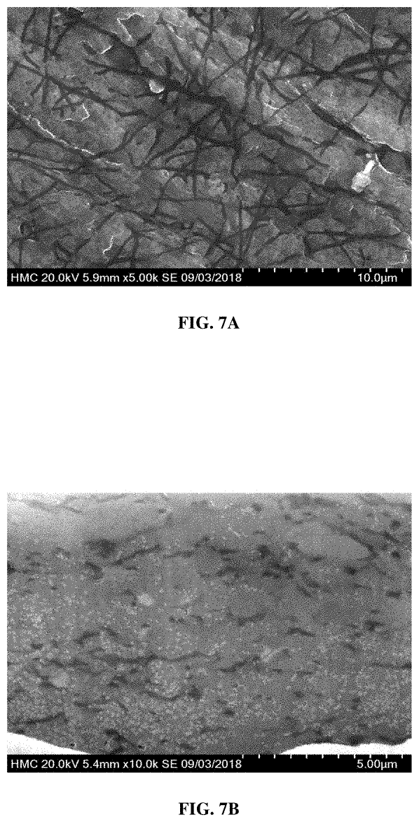

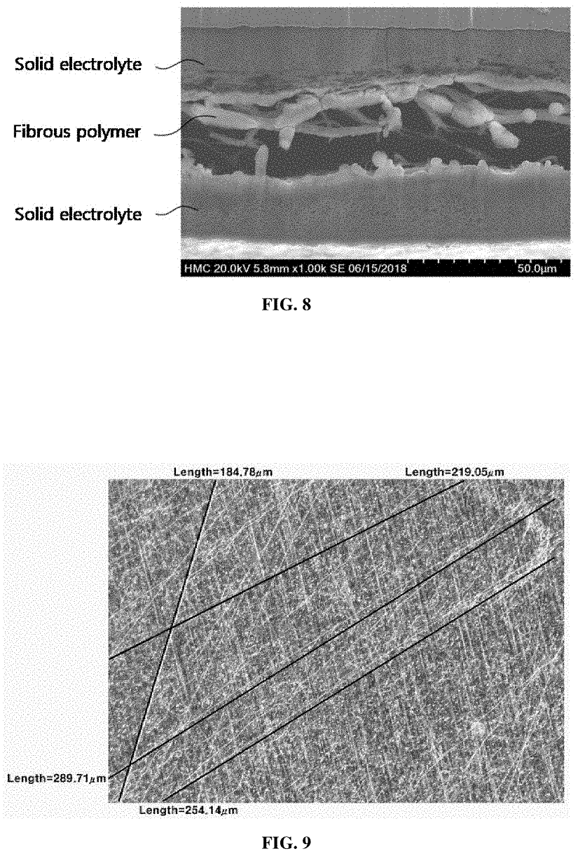

FIG. 7A shows the result of observation with a SEM of the surface of the solid electrolyte composite in Example of the present invention, FIG. 7B shows the result of observation with a SEM of the cross-section thereof, and FIG. 8 shows the result of observation with a SEM of the cross-section of the solid electrolyte composite in Comparative Example.

With reference to FIGS. 7A and 7B, in the solid electrolyte composite of Example, it can be seen that the solid electrolyte was pressed to thus form a dense matrix and that the fibrous polymers were uniformly distributed in the matrix. In contrast, with reference to FIG. 8, in the solid electrolyte composite of Comparative Example, the solid electrolyte was not loaded in the support composed of the fibrous polymers despite pressing of the solid electrolyte. Consequently, it can be confirmed that the solid electrolyte composite according to the present invention was not obtained using the general impregnation process.

FIG. 9 shows the result of observation with an optical microscope of the surface of the solid electrolyte composite in Example of the present invention, from which the average length of the fibrous polymers could be measured. The average length of the fibrous polymers was measured to be about 300 μm.

### Test Example 2—Evaluation of Battery Capacity

An all-solid-state battery including the solid electrolyte composite of Example was manufactured as follows.

(Cathode powder) A cathode powder was prepared by mixing lithium titanium sulfide as an active material, Li₂S-P₂S₅ as a sulfide-based solid electrolyte and Super P as a conductor at a mass ratio of 32.3:64.5:3.2.

(Anode powder) An anode powder was prepared by mixing lithium titanium oxide as an active material, Li₂S-P₂S₅ as a sulfide-based solid electrolyte and Super P as a conductor at a mass ratio of 33.1:66.1:0.8.

(Manufacture of all-solid-state battery) A cathode was formed by applying the cathode powder on one side of the solid electrolyte composite of Example and then performing pressing. An anode was formed by applying the anode powder on the other side of the solid electrolyte composite and then performing pressing. Thereby, the all-solid-state battery of FIG. 1 was obtained.

The all-solid-state battery was charged and discharged at a 0.1C rate in the range of 3.0 to 4.3 V based on Li. The capacity of the all-solid-state battery was measured to be about 90 mAh/g.

Although the examples and test examples of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A solid electrolyte composite, comprising:
a matrix comprising a solid electrolyte; and
fibrous polymers located in the same layer as the matrix and distributed in the matrix.

2. The solid electrolyte composite of claim 1, wherein the solid electrolyte comprises a sulfide-based solid electrolyte, an oxide-based solid electrolyte, or combinations thereof.

3. The solid electrolyte composite of claim 1, wherein the fibrous polymers comprises one or more selected from the group consisting of polyethylene terephthalate, polyimide, polyamide, polysulfone, polyvinylidene fluoride, polyacrylonitrile, polyethylene, and polypropylene.

4. The solid electrolyte composite of claim 1, wherein the fibrous polymers have an average diameter of about 0.001 μm to about 10 μm and an average length of about 150 μm to 10,000 μm.

5. The solid electrolyte composite of claim 1, wherein the solid electrolyte composite has a thickness of about 1 μm to 100 μm.

6. The solid electrolyte composite of claim 1, wherein the solid electrolyte composite is a free-standing thin film.

7. The solid electrolyte composite of claim 1, wherein the solid electrolyte composite has a density variation of about 15% or less.

8. The solid electrolyte composite of claim 1, wherein the solid electrolyte composite has a density of about 1.3 g/cm³ to 4.6 g/cm³.

9. A method of manufacturing a solid electrolyte composite, comprising:
preparing a first solution comprising a polymer material;
preparing a second solution comprising a solid electrolyte;
producing fibrous polymers by electrospinning the first solution and simultaneously obtaining a structure configured such that the solid electrolyte is loaded between the fibrous polymers by electrospraying the second solution; and
pressing the structure.

10. The method of claim 9, further comprising drying the pressed structure.

11. The method of claim 9, wherein the polymer material comprises one or more selected from the group consisting of polyethylene terephthalate, polyimide, polyamide, polysulfone, polyvinylidene fluoride, polyacrylonitrile, polyethylene, and polypropylene.

12. The method of claim 9, wherein the first solution comprises an amount of about 5 wt % to 30 wt % of the polymer material based on the total weight of the first solution.

13. The method of claim 9, wherein the solid electrolyte comprises a sulfide-based solid electrolyte, an oxide-based solid electrolyte, or combinations thereof.

14. The method of claim 9, wherein the solid electrolyte has an average particle diameter of about 0.001 μm to 10 μm.

15. The method of claim 9, wherein the second solution comprises an amount of about 5 wt % to 50 wt % of the solid electrolyte based on the total weight of the second solution.

16. The method of claim 9, wherein the electrospinning is performed using a first unit including a first tank for storing the first solution and a pin-shaped first nozzle for jetting the first solution stored in the first tank.

17. The method of claim 9, wherein the electrospinning is performed under conditions of an applied voltage of about 1 kV to 30 kV, a jetting distance of about 5 cm to 20 cm and a jetting speed of about 5 μl/min to 20 μl/min.

18. The method of claim 9, wherein the electro spraying is performed using a second unit including a second tank for storing the second solution and a pin-shaped second nozzle for jetting the second solution stored in the second tank.

19. The method of claim 9, wherein the electrospraying is performed under conditions of an applied voltage of about 1 kV to 30 kV, a jetting distance of about 5 cm to 20 cm and a jetting speed of about 50 μl/min to 1,000 μl/min.

20. An all-solid-state battery, comprising:
a cathode;
an anode; and
a solid electrolyte composite of claim 1 disposed between the cathode and the anode.
